(19) United States
(12) Patent Application Publication
(10) Pub. No.: US 2024/0262264 A1
(43) Pub. Date: Aug. 8, 2024

(54) VEHICLE SEAT STRUCTURE AND VEHICLE SEAT

(71) Applicant: Faurecia Autositze GmbH, Hannover (DE)

(72) Inventors: Marcin Cieslak, Grójec (PL); Marcin Piotrowski, Lesznowola (PL); Lukasz Tyl, Warsaw (PL)

(21) Appl. No.: 18/432,536

(22) Filed: Feb. 5, 2024

(30) Foreign Application Priority Data
Feb. 6, 2023 (DE) 10 2023 102 827.8

(51) Int. Cl. B60N 2/18

(52) U.S. Cl. CPC B60N 2/1814

(57) ABSTRACT

The invention relates to a vehicle seat structure (1). The vehicle seat structure (1) comprises a seat frame part (5) with a longitudinal section (6) and a backrest section (7). The seat frame part (5) can be pivoted about a pivot axis of a pivot bearing (11) for adjusting the inclination of the vehicle seat. A seat cushion frame part (20) is supported on the seat frame part (5). In one end region, the seat cushion frame part (20) is guided for being displaced on the backrest section (7) of the seat frame part (5) by a guiding device (21). In the other end region, the seat cushion frame part (20) is linked to the longitudinal section (6) of the seat frame part (5) by a coupling pivoting bar (19). By means of a displacement of the seat cushion frame part (20) relative to the backrest section (7) of the seat frame part (5), a height adjustment can be brought about.

### CROSS REFERENCE TO RELATED APPLICATIONS

This application claims priority to co-pending German Patent Application No. DE 10 2023 102 827.8 filed Feb. 6, 2023.

### FIELD OF THE INVENTION

The invention relates to a vehicle seat which is used in particular in a passenger car. Furthermore, the invention relates to a vehicle seat structure of such a vehicle seat, to which a backrest cushion and a seat cushion can be or are attached. In addition to the permanent and reliable support of the backrest cushion and seat cushion, a vehicle seat structure must also allow an adaptation to the size and physiometry of the person sitting on the vehicle seat in the event of a crash. In particular, this adaptation involves adjusting the height of the seat cushion, the angle of inclination of the seat cushion and/or the backrest and/or the extension of the seat cushion in forward direction.

### BACKGROUND OF THE INVENTION

A vehicle seat structure is commonly used in motor vehicles in which a seat cushion frame supporting the seat cushion is supported on a floor rail by a front and a rear coupling pivoting bar in the manner of a four-bar linkage, the floor rail enabling a longitudinal displacement of the entire vehicle seat. By pivoting the coupling pivoting bars together, the seat cushion frame can on the one hand side be displaced in the longitudinal direction of the motor vehicle and on the other hand side the height of the seat cushion frame can be adjusted, which can be accompanied by a pivoting of the seat cushion frame depending on the kinematics of the four-bar linkage. In such known embodiments, a backrest frame, on which a backrest cushion is held, is pivotably held on the seat cushion frame by a pivot bearing, so that it is possible to change the angle of inclination of the backrest frame relative to the seat cushion frame. In this known embodiment, the change in the height of the seat cushion frame and the longitudinal displacement thereof is accompanied by a corresponding change in the height and longitudinal displacement of the backrest frame.

Different kinematics for vehicle seat structures are known in particular from the following publications:

DE 38 22 877 A1 discloses a single-shell seat that forms a seat shell and a backrest shell in one piece and rigidly. In the front end region of the seat shell and in the transition region of the seat shell to the backrest shell, the single-shell seat has lateral bolts, which are guided in slotted-link-like guides. The course of the slotted-link-like guides and their orientation relative to one another is selected in such a way that the movement of the bolts along the slotted-link-like guides leads to a change in the inclination of the one-shell seat. DE 38 22 877 A1 also discloses an embodiment in which the seat shell and the backrest shell are separate from one another, but connected to one another by a pivot bearing. In this case, a bolt guided in a slotted-link-like guide is arranged in the front end region of the seat shell, while the other bolt is provided in the upper end region of the backrest shell. The pivot bearing allows a change of the relative inclination between the seat shell and the backrest shell. Once the angle of inclination has been set, the slotted-link-like guides allow the angle of inclination of the seat shell and the backrest shell to be changed together. The design of the slotted-link-like guides can also be such that when for a movement along the slotted-link-like guides, the seat shell maintains its horizontal position, is moved forwards and is raised slightly, while the angle of inclination of the backrest shell is increased.

U.S. Pat. No. 6,340,208 B1 discloses an angled support strut, the first leg of which is supported on the vehicle floor, while the second leg extends obliquely to the rear and upwards. In the end region of the second leg, a backrest part is pivotably held on the support strut by means of a pivot bearing. The backrest part extends downwards beyond the pivot bearing. In the lower end area, the backrest part has a bearing pin. The bearing pin engages in a slotted link guide, which is arranged in the rear end region of a seat cushion frame part. The seat cushion frame part is linked to the first leg of the support strut by a coupling pivoting bar. Furthermore, the front end region of the seat cushion frame part is connected to a bolt in a slotted link guide oriented in the longitudinal direction, which is provided in the front end region of the support strut. Pivoting the backrest part relative to the support strut results in the seat cushion frame part being moved forwards due to the engagement of the bolt of the backrest part in the slotted link guide of the seat cushion frame part, which is induced by the pivoting of the coupling pivoting bar and the movement of the bolt of the seat cushion frame part in the slotted link guide of the support strut. In the rear end region of the seat cushion frame part between the coupling pivoting bar and the slotted link guide in which the bolt of the backrest part is accommodated, the seat cushion frame part comprises a further slotted link guide which is oriented in the longitudinal direction. A bolt of a seat pan frame part is accommodated in this slotted link guide. In the front end region, a coupling pivoting bar is linked to the seat pan frame part. The other end region of the coupling pivoting bar is linked to the seat cushion frame part. By pivoting the coupling pivoting bar, the seat pan frame part can be pivoted relative to the seat cushion frame part. For other embodiments in U.S. Pat. No. 6,340,208 B1, the seat pan frame part is connected directly to the backrest part without an interposition of a seat cushion frame part by the engagement of a bolt in a slotted link or by a pivot bearing and then linked to the support strut by a scissor-like or toggle lever-like coupling mechanism providing further degrees of freedom. The support strut can also be omitted for a different embodiment, in which case the vehicle seat structure is attached directly to the substructure.

EP 1 131 224 B1 corresponding to U.S. Pat. No. 6,578,917 B1 discloses a vehicle seat with a seat part and a backrest part which are held on a seat support which is supported on a vehicle floor of a motor vehicle. The seat part and the backrest part can be adjusted both relative to the seat support and relative to each other by means of actuators. The seat part and the backrest part are each guided in a slotted link guide so that they can be pivoted together at a predetermined angle of inclination of the backrest part relative to the seat part. The two slotted link guides are oriented at an angle of approximately 90° relative to each other. The slotted link guide by which the backrest part is guided is straight, while the slotted link guide by which the seat part is guided is curved. A basically corresponding embodiment is also known from EP 1 223 835 B1 corresponding to U.S. Pat. No. 6,776,454 B1, although here a movement of the seat part and the backrest part along the slotted links of the seat support is positively coupled with an adjustment of the angle of inclination between the seat part and the backrest part.

Further prior art is known from the publications DE 10 2004 055 643 A1, DE 10 2019 215 769 A1, EP 1 176 048 A1 corresponding to U.S. Pat. No. 6,550,863 B2 and WO 2005/108158 A2 corresponding to U.S. Pat. No. 7,780,230 B2 and U.S. Pat. No. 9,399,415 B2.

### SUMMARY OF THE INVENTION

The invention proposes a vehicle seat structure having a seat frame part. The seat frame part comprises a longitudinal section and a backrest section. A backrest cushion can be supported directly on the backrest section, while the seat cushion can only be supported indirectly on the longitudinal section (as will be explained in more detail below). To adjust the inclination of the vehicle seat, the seat frame part is supported for being pivoted about a pivot axis by a pivot bearing. If the seat frame part is pivoted about the pivot axis, this results in a joint pivoting of the longitudinal section and the backrest section of the seat frame part, which in turn results in the joint pivoting of the backrest cushion and the seat cushion. The vehicle seat structure according to the invention also comprises a seat cushion frame part. This is slidably guided (in particular in the rear end region when seen in the longitudinal direction of the vehicle) on the (preferably lower end region of the) backrest section of the seat frame part. Furthermore, the seat cushion frame part (preferably in the front end region when seen in the longitudinal direction of the vehicle) is linked (preferably in the front end region) to the longitudinal section of the seat frame part by a coupling pivoting bar. By means of a displacement of the seat cushion frame part relative to the backrest section of the seat frame part, a height adjustment can be brought about, which can be a relative height change between the seat cushion and the backrest cushion and/or a height adjustment of the seat cushion and the seat cushion frame part. As a result of the displacement of the seat cushion frame part relative to the backrest section of the seat frame part, a first height adjustment occurs on the one hand in the area of the displaceable guide of the seat cushion frame part on the backrest section of the seat frame part. A second height adjustment can occur in the area of the linkage of the seat cushion frame part to the coupling pivoting bar, as the displacement of the seat cushion frame part relative to the backrest section of the seat frame part results in a pivoting of the coupling pivoting bar. Depending on the design, the first and second height adjustments can be of the same size, which means that the angle of inclination of the seat cushion frame part does not change during this height adjustment. On the other hand, the first and second height adjustments can also differ from each other, which leads to the result that with the displacement of the seat cushion frame part relative to the backrest section of the seat frame part a change in a (mean) height of the seat cushion frame part and/or a change in the inclination of the seat cushion frame part is brought about.

For one solution according to the invention, the pivot bearing and the coupling pivoting bar are guided for being displaced in a longitudinal direction relative to a longitudinal guiding device by guiding devices, which are also referred to below as the first guiding device and the second guiding device. In the simplest case, the longitudinal guiding device is a longitudinal guiding rail attached to the floor of the vehicle, on which both the pivot bearing and an end region of the coupling pivoting bar are supported for being displaced and in a sliding manner. The pivot bearing and the coupling pivoting bar are arranged directly adjacent to the longitudinal guiding device and the guidance takes place without further adjustment options and degrees of freedom between the pivot bearing and the articulated linkage of the coupling pivoting bar on the one hand and the longitudinal guiding device on the other.

An optional advantage of the embodiment according to the invention is that for conventional vehicle seat structures in which the height of the seat cushion frame is adjusted with the backrest frame pivotably hinged to the seat cushion frame, the height adjustment of the seat cushion leads to a height adjustment of the upper end region of the backrest and thus also of a headrest, so that in the event of a crash, depending on the height adjustment used, the head of the person sitting on the vehicle seat is arranged at different heights, which makes it difficult to optimize the position of the head in order to minimize accident injuries. According to the invention, however, the upper end region of the seat frame part may remain at the same height (apart from minor changes as a result of the pivoting of the seat frame part about the pivot axis of the pivot bearing), which enables or improves an optimization of the height of the head to minimize accident injuries.

For one variant of the invention, by the inventive design the height of an upper linkage point of a seat belt may also change to at least a reduced extent.

A further optional advantage of one embodiment according to the invention may be that the displaceable guidance of the seat cushion frame part on the backrest section of the seat frame part can define a movement component in the longitudinal direction of the vehicle. The displacement of the seat cushion frame part relative to the backrest section of the seat frame part and the pivoting of the coupling pivoting bar can then result in that by a height adjustment induced in this way at the same time an automatic change in the longitudinal position of the seat cushion frame part and thus of the seat cushion can be induced, which can be used to adapt the vehicle seat longitudinally to the physiometry of the person sitting on the vehicle seat.

For one embodiment of the vehicle seat structure, the longitudinal section of the seat frame part is supported for being displaced in the longitudinal direction by a first guiding device and a second guiding device relative to or on a longitudinal guiding device, in particular a longitudinal guiding rail or seat rail. In this case, the first guiding device supports the pivot bearing for a pivoting of the seat frame part about the pivot axis, leaving only two degrees of freedom, namely a degree of freedom of rotation due to the pivot bearing and a degree of freedom for a displacement in the longitudinal direction relative to or on the longitudinal guiding device. The second guiding device supports a slotted link guide, which means that only two degrees of freedom are provided here, namely one degree of freedom for movement along the slotted link guide and a further degree of freedom for a displacement in the longitudinal direction relative to or on the longitudinal guiding device. Here, the slotted link guide can be used to ensure the relative movement required to enable the seat frame part to pivot about the pivot bearing. In this case, the slotted link guide can define a circular path that is concentric to the pivot axis of the pivot bearing. The seat cushion frame part is then guided for being displaced on the backrest section of the seat frame part by a third guiding device. As explained above, the seat cushion frame part is also linked to the seat frame part (in this case in the longitudinal section) by the coupling pivoting bar.

In principle, it is possible for the seat cushion to be supported directly on the seat cushion frame part. If for one proposal a further degree of freedom for an adjustment is to be integrated into the vehicle seat structure, the vehicle seat structure can additionally comprise a seat pan frame part. In one end region the seat pan frame part can then be mounted for being pivoted about a pivot axis on the seat cushion frame part, in this end region only the pivot bearing providing a degree of freedom for pivoting movement or optionally an additional degree of freedom for a displacement being present. By pivoting the seat pan frame part about the pivot axis relative to the seat cushion frame part, the angle of inclination of the seat cushion and/or the height of the seat cushion in the front end region can be adjusted.

For one embodiment of the vehicle seat structure, the respective adjustments can be brought about by means of manual actuation, possibly using suitable actuating elements such as sliders, levers or rotary wheels and associated transmissions with gear ratios or reductions, or by means of a suitable drive, wherein in both cases the adjustment can be brought out by a transmission of any design.

For one proposal, the seat cushion frame part is displaced relative to the backrest section of the seat frame part by a geared connection, which can be arranged, for example, in the area of the second guiding device. This geared connection can be a spindle drive, for example. It is also possible that the displacement is brought about by means of a rack and pinion drive. A rack and pinion drive of this type can also be used to advantage if the displacement is not linear but follows a curved path. In this case, a rack contour curved according to the curved path can be used. A pinion meshing with the rack can then be driven manually or driven by means of an electric drive, for example.

The third guiding device, by which the seat cushion frame part is guided for being displaced on the backrest section of the seat frame part, can be realized in a variety of ways. For one proposal, the third guiding device is a second slotted link guide. The second slotted link guide then comprises a slotted link in which a slotted link sliding element is arranged, which is moved along the slotted link in a sliding manner during the displacement. The use of such a second slotted link guide has proven to be cost-effective, yet very reliable. The second slotted link guide also ensures the required mechanical strength in the event of a crash.

For this solution, it is generally possible that the backrest section of the seat frame part comprises the slotted link sliding element, while the seat cushion frame part comprises the slotted link. However, for one proposal the backrest section of the seat frame part comprises the slotted link, while the seat cushion frame part comprises the slotted link sliding element. Here, “comprising” is understood to mean that the slotted link respectively the slotted link sliding element is embodied as a direct part of the seat frame part or seat cushion frame part or is embodied as a separate part of a base body thereof and is then held on the base body.

The invention also offers a wide range of possibilities for causing the seat frame part to pivot about the pivot axis, which include different designs of a gearbox used for this purpose. In one proposal, a spindle drive or a rack and pinion drive is used to cause the seat frame part to pivot about the pivot axis. To give merely one non-limiting example of inventive embodiments, a rack and pinion drive may be arranged in the region of the second guiding device. In this case, a rack may be curved according to the curve shape of a slotted link guide of the second guiding device. Since in this case the rack and pinion drive is arranged at a distance from the first guiding device defining the pivot axis, the force transmitted by means of the rack and pinion drive to bring about the pivoting is applied to the seat frame part with a large lever arm, which results in small actuating forces and low mechanical stresses on the rack and pinion drive.

The invention also proposes a vehicle seat comprising a vehicle seat structure as previously explained. In this case, a backrest cushion is held on the backrest section of the seat frame part, while a seat cushion is held on the seat cushion frame (or the seat pan frame part held on the seat frame).

Advantageous developments of the invention result from the claims, the description and the drawings.

The advantages of features and of combinations of a plurality of features mentioned at the beginning of the description only serve as examples and may be used alternatively or cumulatively without the necessity of embodiments according to the invention having to obtain these advantages.

The following applies with respect to the disclosure—not the scope of protection—of the original application and the patent: Further features may be taken from the drawings, in particular from the illustrated designs and the dimensions of a plurality of components with respect to one another as well as from their relative arrangement and their operative connection. The combination of features of different embodiments of the invention or of features of different claims independent of the chosen references of the claims is also possible, and it is motivated herewith. This also relates to features which are illustrated in separate drawings, or which are mentioned when describing them. These features may also be combined with features of different claims. Furthermore, it is possible that further embodiments of the invention do not have the features mentioned in the claims which, however, does not apply to the independent claims of the granted patent.

The number of the features mentioned in the claims and in the description is to be understood to cover this exact number and a greater number than the mentioned number without having to explicitly use the adverb “at least”. For example, if an element is mentioned, this is to be understood such that there is exactly one element or there are two elements or more elements. Additional features may be added to these features, or these features may be the only features of the respective product.

The reference signs contained in the claims are not limiting the extent of the matter protected by the claims. Their sole function is to make the claims easier to understand.

Many variations and modifications may be made to the preferred embodiments of the invention without departing substantially from the spirit and principles of the invention. All such modifications and variations are intended to be included herein within the scope of the present invention, as defined by the following claims.

### BRIEF DESCRIPTION OF THE FIGURES

In the following, the invention is further explained and described with reference to preferred embodiments shown in the figures.

FIG. 1 shows a highly schematized representation of a vehicle seat structure with a seat frame part and a seat cushion frame part in a side view.

FIG. 2 shows a further highly schematized embodiment of a vehicle seat structure with a seat frame part, a seat cushion frame part and a seat pan frame part.

FIG. 3 shows a three-dimensional view of a design of a vehicle seat structure.

FIG. 4 shows the vehicle seat structure according to FIG. 3 in a partially disassembled state or longitudinal section in an initial position.

FIG. 5 shows the vehicle seat structure according to FIGS. 3 and 4 in a state rearwardly inclined when compared to the inclination according to FIG. 4.

FIG. 6 shows the vehicle seat structure according to FIGS. 3 to 5 in a state forwardly inclined when compared to the inclination in FIG. 4.

FIG. 7 shows the vehicle seat structure as shown in FIGS. 3 to 6, the height of the seat cushion frame being increased over the state shown in FIG. 4 (by displacing the seat cushion frame part in the area of the third guide arrangement upwards relative to the seat frame part and pivoting the coupling pivoting bar to the rear).

FIG. 8 shows the vehicle seat structure according to FIGS. 3 to 7, the height of the seat cushion frame being reduced when compared to the state shown in FIG. 4 (by displacing the seat cushion frame part relative to the seat frame part downwards in the area of the third guiding device and by pivoting the coupling pivoting bar in forward direction).

### DETAILED DESCRIPTION

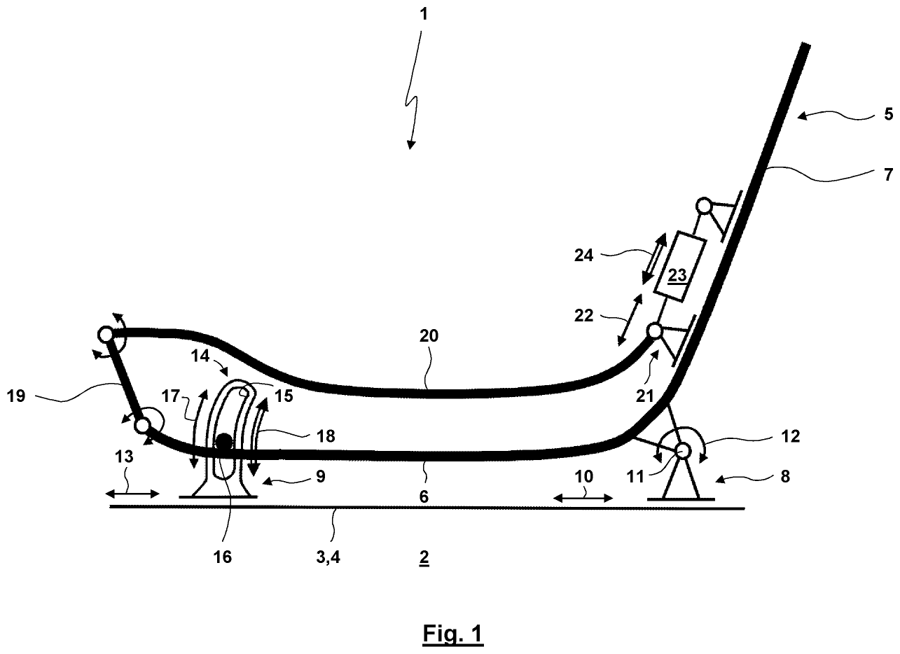

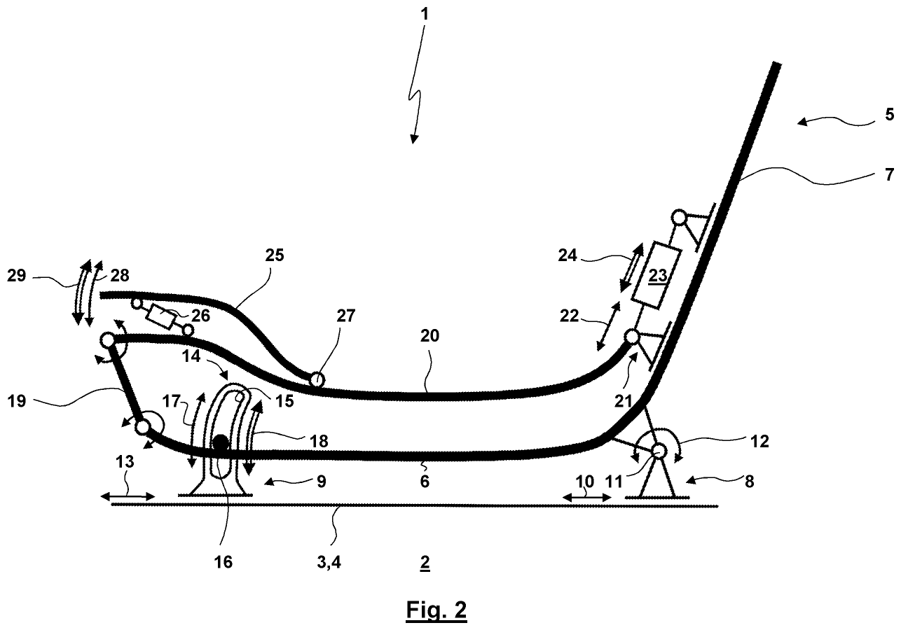

In FIGS. 1 and 2, the degrees of freedom of the components are indicated by arrows with a single line, while manual or actuator-induced movements are indicated by arrows with a double line.

FIG. 1 shows a highly schematized and exemplary mechanical equivalent diagram of a vehicle seat structure 1. Here, the geometry of the components of the mechanical equivalent diagram shown, the course and orientation of the relative degrees of freedom of the components shown, the curve shape of the components shown and the relationship of the dimensions of the components to one another shown are not intended to have any limiting effect.

The vehicle seat structure 1 is supported on a floor 2 of a vehicle. For this purpose, a longitudinal guiding device 3 (which is preferably a longitudinal guiding rail 4) is attached to the floor 2.

The vehicle seat structure 1 comprises a seat frame part 5. The seat frame part 5 comprises a longitudinal section 6 extending in the longitudinal direction of the vehicle and a backrest section 7. The longitudinal section 6 and the backrest section 7 are rigidly connected to each other and are arranged at an angle which depends on the desired angle between a seat cushion and a backrest. The seat frame part 5 is held on the longitudinal guiding device 3 by a first guiding device 9 and a second guiding device 10, the guiding devices 8, 9 being spaced apart from each other in the longitudinal direction. The guiding device 8 is arranged in the rear end region of the longitudinal section 6 or in the transition region between the longitudinal section 6 and the backrest section 7. In contrast, the second guiding device 9 is arranged in the front end region of the longitudinal section 6.

In the area of the first guiding device 8, the vehicle seat structure 1 comprises two degrees of freedom, namely a degree of freedom for a displacement 10, which is provided by a sliding movement along the longitudinal guiding rail 4, and a degree of freedom for a pivoting movement 12 about a transverse vehicle axis, which is provided by a pivot bearing 11.

In the area of the second guiding device 9, the vehicle seat structure 1 also comprises two degrees of freedom, namely a degree of freedom for a displacement 13, which is provided by a sliding movement along the longitudinal guiding rail 4, and a degree of freedom of the slotted link 17, which is provided by a slotted link guide 14 with a slotted link 15, in which a slotted link sliding element 16 is guided in a sliding manner. The slotted link 15 is concentric to the pivot axis, which is defined by the pivot bearing 11. The slotted link sliding element 16 is attached to the longitudinal section 6 of the seat frame part 5. As a result of the coupling by the seat frame part 5, the degree of freedom of pivoting movement 12 in the area of the first guiding device 8 correlates with the degree of freedom of the slotted link 17 in the area of the second guiding device 9. An actuator can be used to bring about a displacement 18, which leads to a pivoting of the seat frame part 5 about the pivot bearing 11 and thus to a change in the inclination of the seat frame part 5. To bring about the displacement 18, an actuator can exert an actuating force on the seat frame part 5 at any point. For the embodiment explained in detail below, the actuator for generating the displacement 18 is arranged in the area of the second guiding device 9 (see also actuator 39 below). The actuator can then comprise a rack curved in accordance with the slotted link 15, into which a pinion driven by the motor can engage. In this case, the motor with the pinion can be held on the seat frame part 5.

One end section of a coupling pivoting bar 19 is pivotably attached to the front end section of the seat frame part 5. The other end section of the coupling pivoting bar 19 is linked to a front end section of a seat cushion frame part 20. The seat cushion frame part 20 extends (in rough approximation or approximately) parallel to the longitudinal section 6 of the seat frame part 5. A rear end section of the seat cushion frame part 20 is guided for being displaced on the backrest section 7 of the seat frame part 5 by a third guiding device 21. The third guiding device 21 comprises only a degree of freedom for a displacement 22. By means of an actuator 23, a displacement 24 can be caused along the degree of freedom for a displacement 22. The actuator 23 is supported on the seat frame part 5.

The vehicle seat structure 1 as shown in FIG. 1 allows the following adjustments:
a) Longitudinal adjustment of the vehicle seat structure is possible by means of the degrees of freedom of displacement 10, 13 of the first and second guiding devices 8, 9. This displacement in the longitudinal direction of the vehicle allows the seat frame part 5 and the seat cushion frame part 20 to be moved together without a change of their heights and angles of inclination.
b) It is possible to pivot the seat frame part 5 about the pivot axis provided by the pivot bearing 11 in the area of the first guiding device 8 with the associated movement in the slotted link 14 along the degree of freedom of the slotted link 17. In this way, the inclination of the seat frame part 5 is changed. The inclination of the seat cushion frame part 20 is changed to the same extent.
c) If the rear end of the seat cushion frame part 20 moves downwards relative to the seat frame part 5 along the degree of freedom for a displacement 22, this is accompanied by a counterclockwise pivoting of the coupling pivoting bar 19. Depending on the orientation of the degree of freedom for a displacement 22, the rear end region of the seat cushion frame part 20 is displaced with one component in forward direction and a first downward height adjustment takes place here. Depending on the geometric properties, the pivoting of the coupling pivoting bar 19 correlates with this, which leads to a component of a movement of the front end region of the seat cushion frame part 20 in forward direction and a second downward height adjustment of the front end region of the seat cushion frame part 20. Depending on the geometry selected, in this way it is possible that only a forward and downward movement of the seat cushion frame part 20 takes place, while the first and second height adjustments are the same. Accordingly, no adjustment in the inclination of the seat cushion frame part 20 takes place. It is also possible that the first and second height adjustments differ from each other, so that a change in the inclination of the seat cushion frame part 20 takes place.

It is possible that a backrest cushion is supported or attached to the backrest section 7 of the seat frame part 5, while a seat cushion can be supported directly or indirectly on the seat cushion frame part 20. Thus, the aforementioned adjustments can apply correspondingly to the seat cushion and the backrest cushion.

FIG. 2 shows an embodiment in which the vehicle seat structure 1 comprises an additional seat pan frame part 25. In this case, the seat cushion is supported (at least in the front end region) on the seat pan frame part 25. By means of a further actuator 26, a change in the relative position of the seat pan frame part 25 (and thus of the seat cushion) relative to the seat cushion frame part 20 can be brought about. For the embodiment shown, the seat pan frame part 25 is linked to the seat cushion frame part 20 by a pivot bearing 27. The seat pan frame part 25 extends forward from the pivot bearing 27 to the front end region of the vehicle seat, which may coincide with the front end region of the seat cushion frame part 20. In this case, the actuator 26 is interposed between the seat cushion frame part 20 and the seat pan frame part 25.

FIG. 2 shows a degree of freedom for a pivoting movement 28 of the seat pan frame part 25 and the displacement 29 brought about by means of the actuator 26. This additional adjustment option can be used to allow to raise a front end portion of a seat cushion and/or to adjust the angle of inclination of the seat cushion independently of the other adjustment options.

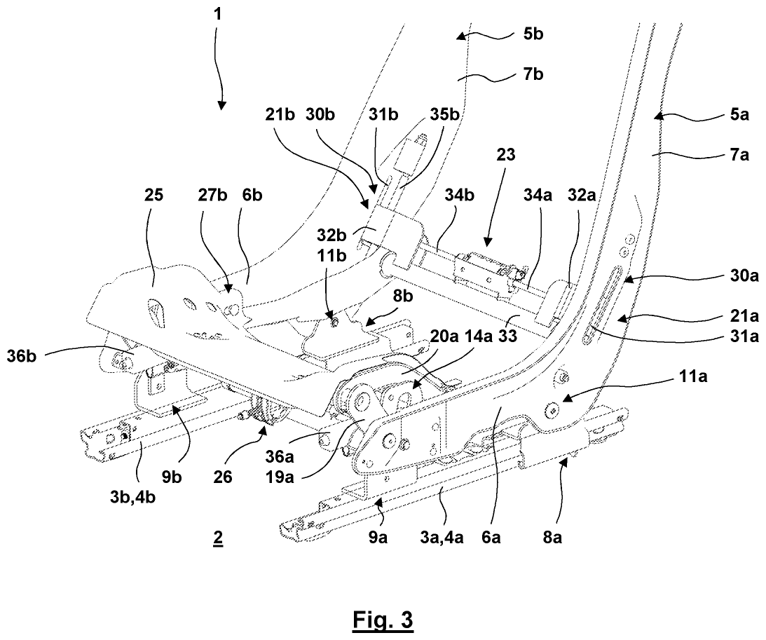

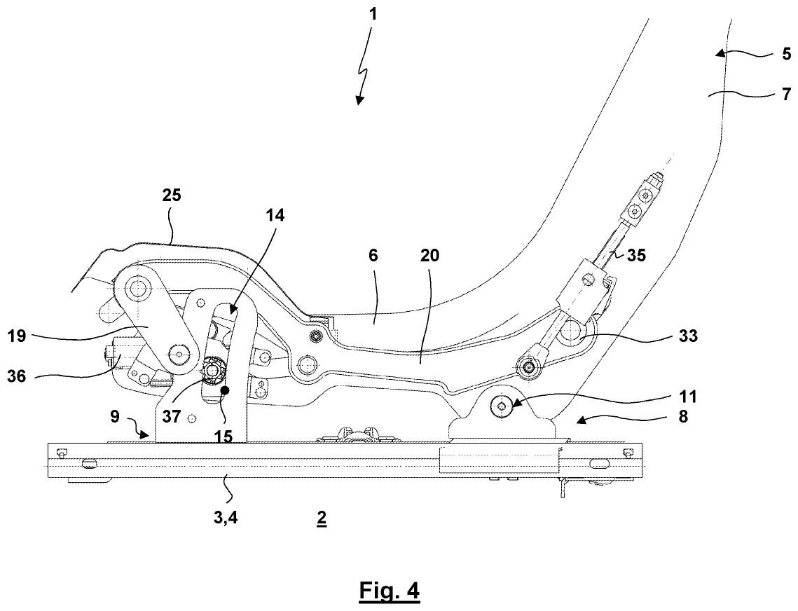

FIGS. 3 to 8 show a design embodiment of a vehicle seat structure 1. In FIGS. 3 and 4, the vehicle seat structure 1 is in an initial position, which may be a reference operating position or design operating position.

It can be seen that the components shown in FIG. 2 are each arranged on the right and left side of the vehicle seat, so that they are each present in pairs. In FIGS. 3 to 8, the same reference numbers are used for the components as in FIG. 1, the components in the pairs of components being distinguished from one another by the additional letters a, b. Reference is made here to the components with or without the additional letter, whereby the explanations can then apply to one of the components or both components.

It can be seen in FIG. 3 that the third guiding device 21 is embodied as a second slotted link guide 30. The second slotted link guide 30 comprises a slotted link 31, which is provided here as an elongated hole or slot or other slotted link in the backrest section 7 of the seat frame part 5. The second slotted link guide 30 has a slotted link sliding element 32, which is attached to the end region of the seat cushion frame part 20 and/or a rear transverse bar 33, which firmly connects the two seat cushion frame parts 20a, 20b to one another.

According to FIG. 3, a single actuator 23 is used, comprising two coaxial output shafts 34a, 34b, each of which is connected to an associated third guiding device 21a, 21b. For the embodiment shown, the two output shafts 34 each drive a spindle drive 35. The rotation of the output shafts 34 and the resulting driving of the spindle drives 35 leads to a movement of the slotted link sliding element 32 along the slotted link 31. With regard to a possible embodiment for the drive by a spindle drive 35, reference is made by way of example to the publication DE 100 60 715 C1 (wherein in the present case it is also possible that the sliding sleeve according to DE 100 60 715 C1 is not used).

In the front end region, the seat frame parts 5 and/or the seat cushion frame parts 20 can be rigidly connected to each other by a front transverse bar.

Furthermore, actuators 36a, 36b can be seen in FIGS. 3 and 4. The actuators 36 drive associated pinions 37a, 37b, which mesh with toothed racks that extend according to the slotted links 15. The actuators 36 can be used to cause the seat frame part 5 to pivot about the pivot bearing 11.

A pivoting of the vehicle seat structure 1 is explained below, starting from the initial position shown in FIGS. 3 and 4:

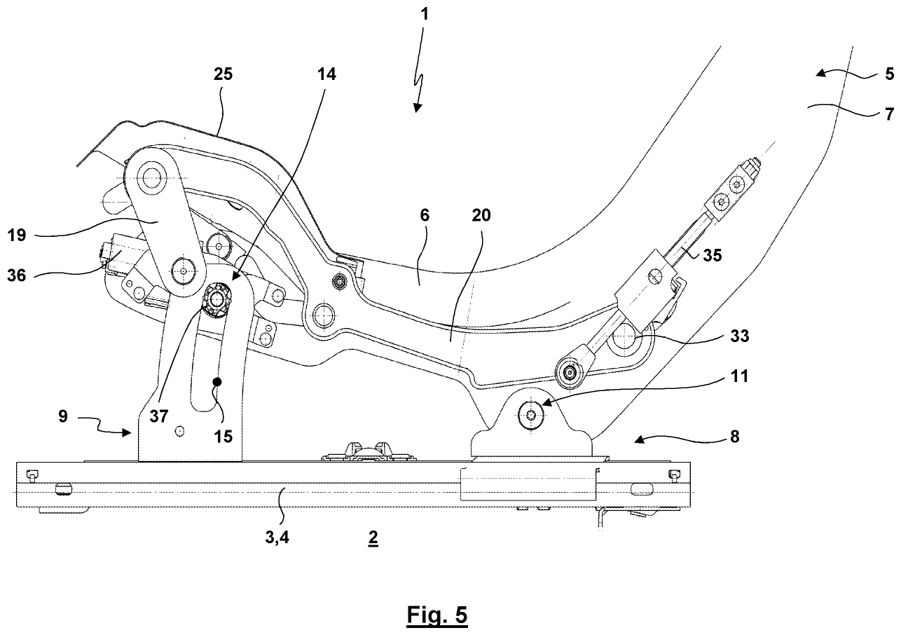

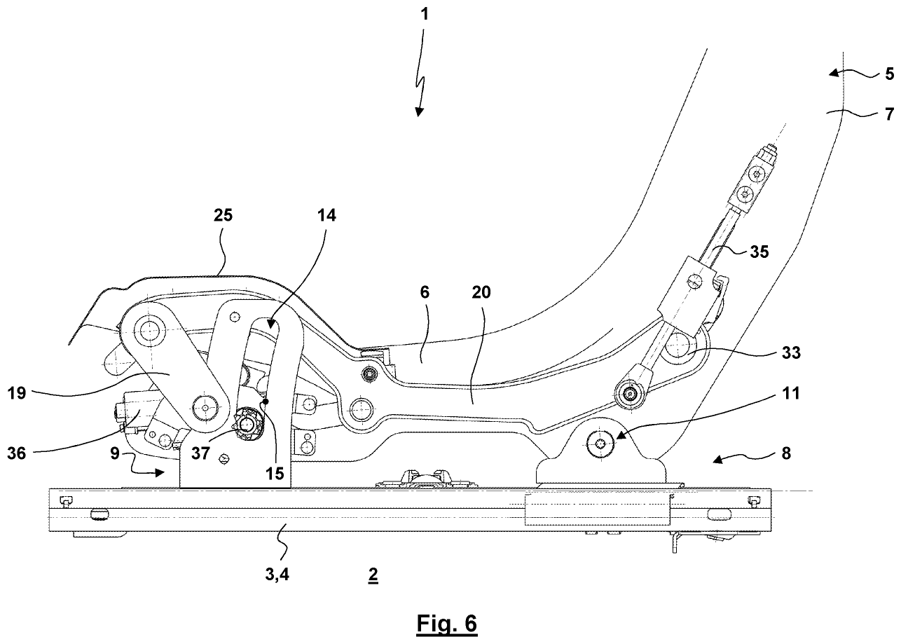

By actuating the drives 36 and moving the pinions 37 along the rack (which is not shown) the vehicle seat can be pivoted backwards as shown in FIG. 5 and forwards as shown in FIG. 6 when the pinion 37 is driven in the opposite direction.

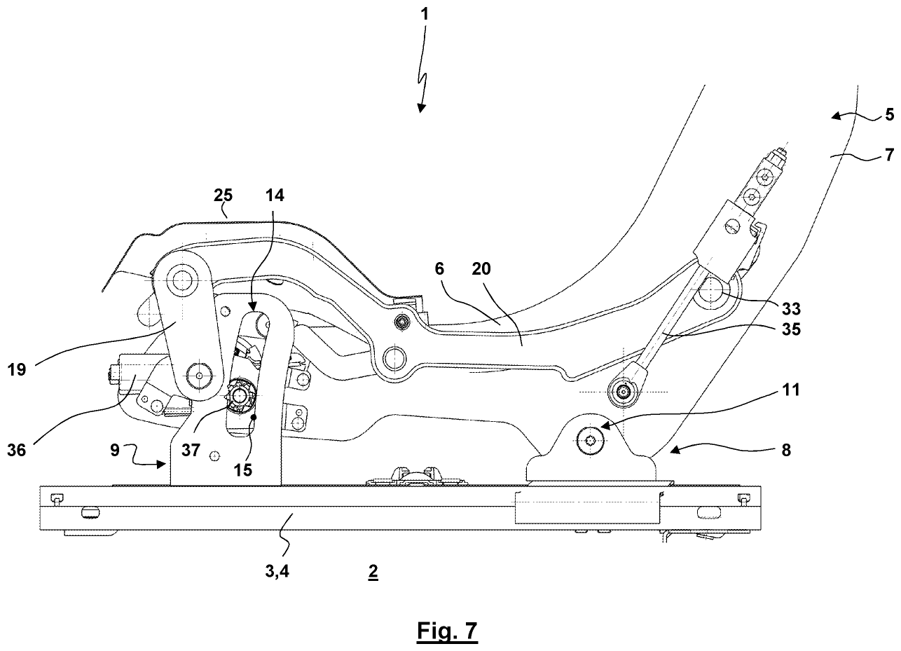

Furthermore, by operating the actuator 23, an increase in the height of the seat cushion frame part 20 and thus also of the seat pan frame part 25 can be brought about, which is accompanied by the clockwise pivoting of the coupling pivoting bar 19 (see FIG. 7).

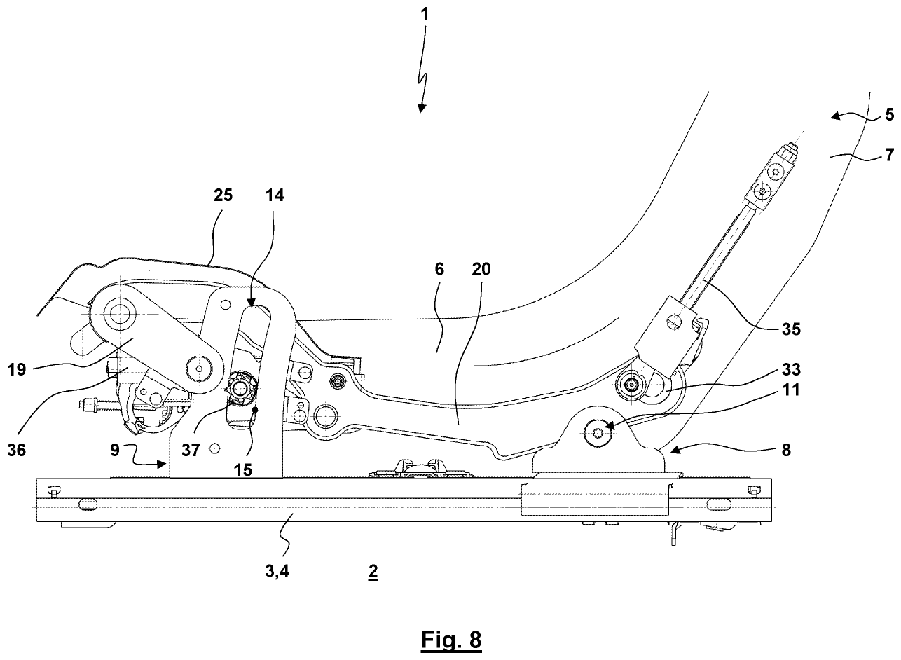

When the actuator 23 is driven in reverse direction, a reduction in height can be brought about, which is associated with a counterclockwise pivoting of the coupling pivoting bar 19 and is shown in FIG. 8.

If actuators are used on the different sides of the vehicle seat to generate a common positioning movement, the drivings of the two actuators have to be synchronized with each other.

We claim:

1. A vehicle seat structure for a vehicle seat, the vehicle seat structure comprising
a) a seat frame part comprising a longitudinal section and a backrest section, the seat frame part being supported for being pivoted about a pivot axis by a pivot bearing so that by pivoting the seat frame part about the pivot axis the inclinations of the longitudinal section and of the backrest section are adjusted in a common adjusting movement,
b) a seat cushion frame part, which is guided for being displaced on the backrest section of the seat frame part and is linked by a coupling pivoting bar to the longitudinal section of the seat frame part wherein by means of a displacement of the seat cushion frame part relative to the backrest section of the seat frame part the height of the seat cushion frame part is adjusted, and
c) a first guiding device and a second guiding device which guide the pivot bearing and the coupling pivoting bar for being displaced in a longitudinal direction relative to a longitudinal guiding device.

2. The vehicle seat structure of claim 1 wherein
a) the longitudinal section of the seat frame part is guided by the first guiding device and the second guiding device for being displaceable in the longitudinal direction relative to the longitudinal guiding device and the first guiding device supports the pivot bearing and the second guiding device supports a slotted link guide and
b) the seat cushion frame part is guided for being displaced on the backrest section of the seat frame part by a third guiding device and is linked to the seat frame part by the coupling pivoting bar.

3. The vehicle seat structure of claim 2 wherein a seat pan frame part which is mounted in one end region by a pivot bearing on the seat cushion frame part for being pivotable about a pivot axis, wherein by a pivoting of the seat pan frame part about the pivot axis relative to the seat cushion frame part an angle of inclination of the seat cushion and/or a height of the seat cushion in the front end portion are/is adjusted.

4. The vehicle seat structure of claim 1, wherein a displacement of the seat cushion frame part relative to the backrest section of the seat frame part can be brought about by a spindle drive or a rack and pinion drive.

5. The vehicle seat structure of claim 2, wherein the third guiding device is a second slotted link guide comprising a slotted link and a slotted link sliding element moving along the slotted link.

6. The vehicle seat structure of claim 5, wherein the backrest section of the seat frame part comprises the slotted link and the seat cushion frame part comprises the slotted link sliding element.

7. The vehicle seat structure of claim 1, wherein a pivoting of the seat frame part about the pivot axis can be brought about by a spindle drive or a rack and pinion drive.

8. The vehicle seat with a vehicle seat structure of claim 1, wherein a backrest cushion is held on the backrest section of the seat frame part and a seat cushion is held on the seat cushion frame part or the seat pan frame part.
